(19) United States
(12) Patent Application Publication
(10) Pub. No.: US 2007/0097584 A1
(43) Pub. Date: May 3, 2007

(54) High current surge panel with diagnostics

(76) Inventors: David Ducharme, Santee, CA (US); Ken Clark, Cypress, TX (US); Pieter Loftus, San Diego, CA (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/367,165

(22) Filed: Mar. 2, 2006

Related U.S. Application Data
(60) Provisional application No. 60/658,069, filed on Mar. 3, 2005.

(51) Int. Cl. H02H 9/06

(52) U.S. Cl. 361/118

(57) ABSTRACT

A transient voltage surge suppressor (TVSS) device, suitable for commercial/industrial applications, incorporates diagnostic circuitry. The TVSS provides seven modes of protection for three phases of a typical electrical service. A surge panel can protect against large current transients. The large current-handling capability stems from passing a large amount of surge current from one layer of a multilayer printed circuit to another through the use of arrays of plated through holes.

### CROSS-REFERENCE TO RELATED APPLICATION

This application claims the benefit of U.S. Provisional Application No. 60/658,069, filed Mar. 3, 2005.

### FIELD OF THE INVENTION

This invention relates to transient voltage surge suppression (TVSS) devices, and more particularly to TVSS devices for commercial and industrial applications where the devices incorporate diagnostic circuitry.

### BACKGROUND OF THE INVENTION

Transient voltage surge suppression (TVSS) devices, referred to interchangeably herein as surge suppressors and voltage-clamping devices, are commonly known for use in suppressing such over-voltage transients to protect voltage-surge intolerant circuitry. TVSS devices include nonlinear, voltage-dependent resistive elements which display electrical behavior similar to that displayed by a pair of series-connected, back-to-back Zener diodes. At normal voltages, below the TVSS clamping voltage level, TVSS devices display a high resistance with a small leakage current. When subjected to a large transient voltage (a voltage above the clamping voltage of the TVSS device), the TVSS device may operate in a low resistance region which increases current flow through the device. When the voltage is increased, the TVSS, due to its characteristics, presents a lower resistance path to a current from a power source, thereby diverting most of the current away from connected circuitry. The potentially destructive surge energy can be dissipated or passed through the voltage-clamping (TVSS) device and its operating current returns to its normal range after the surge.

Metal oxide varistors (MOVs) may be utilized as TVSS devices. One technique for protecting metal oxide varistors (MOVs) requires adding a current fuse in series with the MOV, which trips to an open state to protect the MOV when particular transient over-voltages are detected. Transients with I²t ratings that are greater than the fuse rating but just below the MOV rating will blow the fuse, electrically removing the MOV from the over-voltage condition. Under circumstances where the fuse displays an I²t rating such that commonly occurring transients are insufficient to blow the fuse (that is, from a few to 10,000 amperes) but of insufficient magnitude to force the MOV to its low impedance state, the MOV may be subjected to overheating, possibly leading to thermal runaway. Steady state, abnormal over-voltage conditions below those at which the fuse will blow may also generate sufficiently high currents through the MOV leading to dangerous overheating.

A second common technique for protecting MOVs from overheating due to abnormal steady state or transient over-voltage conditions utilizes a thermal cutoff device (TCO) provided electrically in series with the MOV. A TCO is an electrical device that senses the temperature of a surface of an object such as an electrical circuit and trips to a high impedance state (open circuit) at a particular maximum rated temperature. When a TCO is connected in series with an MOV, the TCO senses the surface temperature of the MOV and trips to an open circuit at a particular maximum rated temperature, cutting off voltage to the MOV.

In order to dissipate large surge currents, the TVSS device is typically connected to a bus bar. However, the clamping performance of the surge protector may be degraded by the wide spacing of the bus bars and the additional mechanical connections required to build a bus bar type panel. The mechanical connections lead to greater resistance and thus reduced performance in conducting the surge current.

Another method of dissipating surge currents is described in U.S. Pat. No. 5,303,116 (Grotz). This patent describes a surge protector whose components are mounted on a printed circuit board (PCB), with the circuit leads configured to present a large surface area, so that the surge current runs along the surface of the board.

It is also desirable to gather and store information relating to voltage surge events, particularly the time and magnitude of the surge. The TVSS device therefore preferably has diagnostic circuitry with a surge sensing circuit including a peak detector. A typical peak detector uses an op-amp to amplify the transient signal to a more usable level. The output of the op-amp first goes through a forward biased diode and then to a capacitor. The diode acts as a one-way gate. The capacitor in effect holds the charge of the amplified transient signal even after the transient subsides. The diagnostic circuitry measures the voltage on the capacitor to determine the level of the transient. The capacitor requires a finite amount of time, characterized by the RC time constant, to charge up to the transient level. The longer the capacitor takes to charge, the likelier it is to not reach the peak of the transient before the transient subsides. A fast charging capacitor would be preferable, but the capacitor would then be quicker to discharge once it is measured by the diagnostic circuitry. For the signal to be usable (e.g. readable by a microprocessor), the capacitor must be capable of holding the charge long enough for the signal to be read.

Accordingly, there is a need for a TVSS device which provides improved conduction and dissipation of surge currents, fast response in the diagnostic circuitry, and a surge event signal readable by a microprocessor.

### SUMMARY OF THE INVENTION

The present invention addresses the above-described need by providing a commercial/industrial TVSS which incorporates diagnostic circuitry. According to one aspect of the invention, seven modes of protection are provided for three phases of a typical electrical service, with a surge protection module for each mode. Large current transients may be handled by the device by dissipating the current in a multilayer PCB having the surge protection modules mounted thereon. The surge current passes from one layer of the PCB to another through arrays of plated through holes extending through the PCB..

### BRIEF DESCRIPTION OF THE DRAWINGS

FIG. 1 is a schematic diagram of a surge module incorporated in a TVSS according to an embodiment of the invention.

FIGS. 2A and 2B are top and side views, respectively, of a surge module diagnostics printed circuit board (PCB) assembly.

FIG. 3 is a schematic diagram of a membrane switch used in an embodiment of the invention.

FIGS. 4A and 4B are side and top views, respectively, of a surge module printed circuit board assembly.

FIG. 5 is an illustration of an assembly of a surge module.

FIG. 6 is an illustration of a surge module printed circuit board.

FIG. 7 is a schematic diagram of a surge module diagnostics circuit, in accordance with an embodiment of the invention.

FIG. 8. is an illustration of a surge module diagnostics printed circuit board.

FIG. 9A is a schematic block diagram of a surge sensing circuit in accordance with an embodiment of the invention.

FIG. 9B is a schematic diagram of a peak detector circuit including an emitter follower, in accordance with an embodiment of the invention.

FIGS. 10A and 10B illustrate a sub-panel including a membrane switch and a display, in accordance with an embodiment of the invention.

FIG. 11 is an illustration of a liquid crystal display and driver assembly incorporated in an embodiment of the invention.

FIG. 12 illustrates an implementation of a liquid crystal display in an embodiment of the invention.

FIG. 13 is an illustration of a main surge module assembly including seven surge modules, in accordance with an embodiment of the invention.

FIG. 14 is a schematic diagram of a main surge module assembly.

FIGS. 15A and 15B are edge and plan views, respectively, of a main surge module assembly printed circuit board (PCB).

FIG. 16 is an assembly drawing showing mounting of modules and components on the main surge module assembly PCB.

FIGS. 17A-17E respectively illustrate five printed circuit board layers for the main surge module assembly PCB, in accordance with an embodiment of the invention.

### DETAILED DESCRIPTION

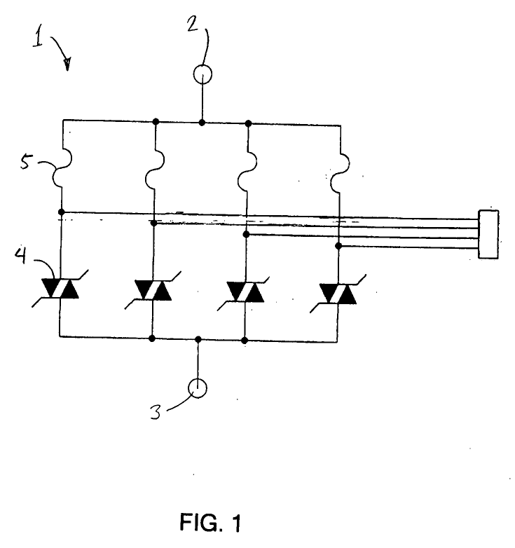

A preferred embodiment of the invention will be described in which voltage surge protection is provided for a typical 3-phase commercial/industrial electrical service. There are seven distinct modes of surge protection for the three phases: line 1 to ground, line 1 to neutral, line 2 to ground, line 2 to neutral, line 3 to ground, line 3 to neutral and neutral to ground. A surge protection module is provided for each of these modes. As shown in FIG. 1, an individual surge protection module 1 (referred to herein simply as a surge module) has input/output terminals 2, 3 connected according to one of the seven above-noted combinations (e.g. the first module has its input connected to line 1 and its output connected to ground, etc.). Module 1 has four parallel branches, each of which has a metal oxide varistor (MOV) 4 in series with a thermal cut-off device (TCO) 5 protecting the MOV. Each module includes a double-sided printed circuit board (PCB) having the MOVs and TCOs mounted thereon. Surge protection can be provided by redirecting a surge from line 1, line 2 and/or line 3 to ground or neutral. The number of MOVs in each module (four in this embodiment) is chosen so as to match the desired surge current rating for the overall device with the surge current rating of an individual MOV. As discussed in more detail below, the PCB is provided with a large number of plated through holes to conduct current between layers of the PCB and thus to efficiently dissipate surge currents.

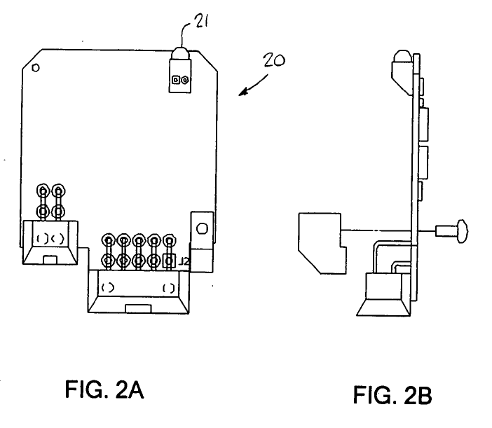

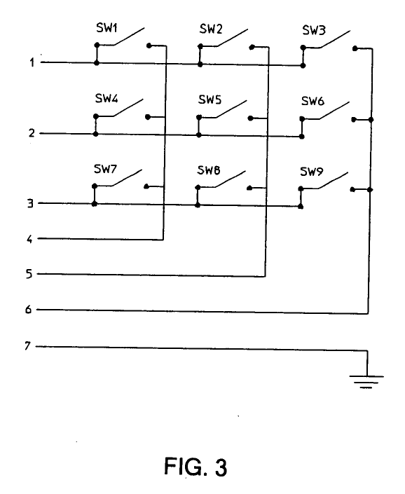

Each of the seven surge modules includes diagnostic circuitry mounted on a PCB 20, as shown in FIGS. 2A and 2B. The diagnostic circuits for the modules interface with a main board of the device through a ten pin connector. Each module has a two-color light-emitting diode (LED) 21 which indicates whether a TCO has failed; a green LED indicates that all TCOs in the module are closed, while a red LED indicates that one or more of the TCOs in the module have opened. A signal also may be sent to a main diagnostic board (described in more detail below) to provide an audible alarm and a display of the current level of surge protection (e.g. “module #1 75% ”after one TCO has failed). The main diagnostic board preferably is connected to a panel including a membrane switch (shown schematically in FIG. 3) for disabling the audio alarm, scrolling through displays relating to different modules, etc.

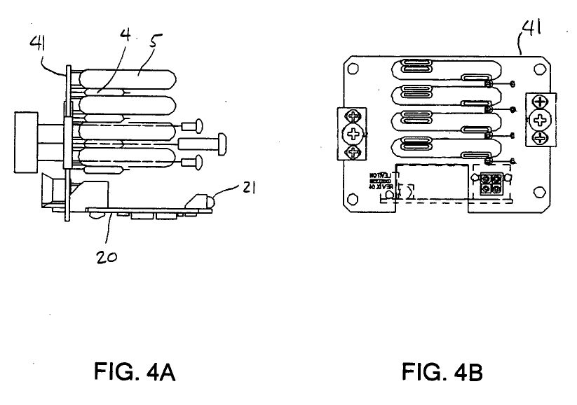

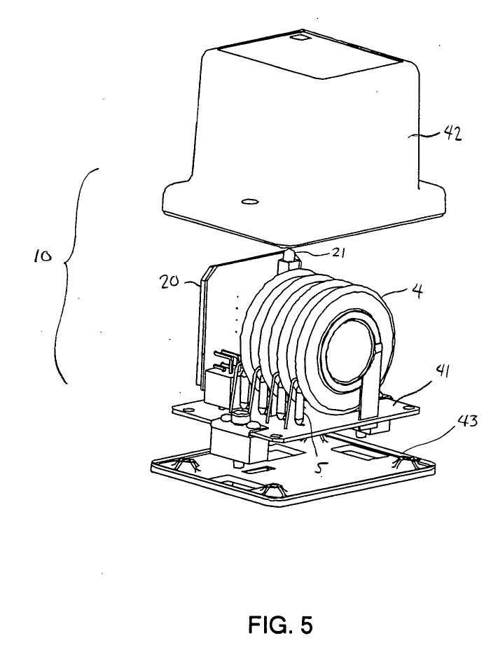

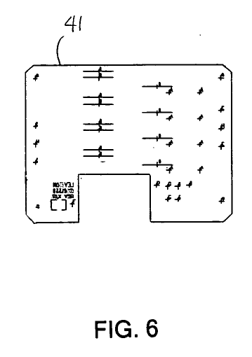

The four MOVs 4 and TCOs 5 are mounted on a PCB 41 (as shown in FIGS. 4A and 4B), along with the diagnostic board 20 including the LED 21. An assembly 10 for each of the surge modules is shown in FIG. 5. The module has a housing (typically of polycarbonate) including a cover 42 and a base plate 43. The PCB 41 (see FIG. 6) is plated on both sides with copper (the plating being typically 3 ounces of copper per square foot) with plated through holes providing connections from one side of the board to the other.

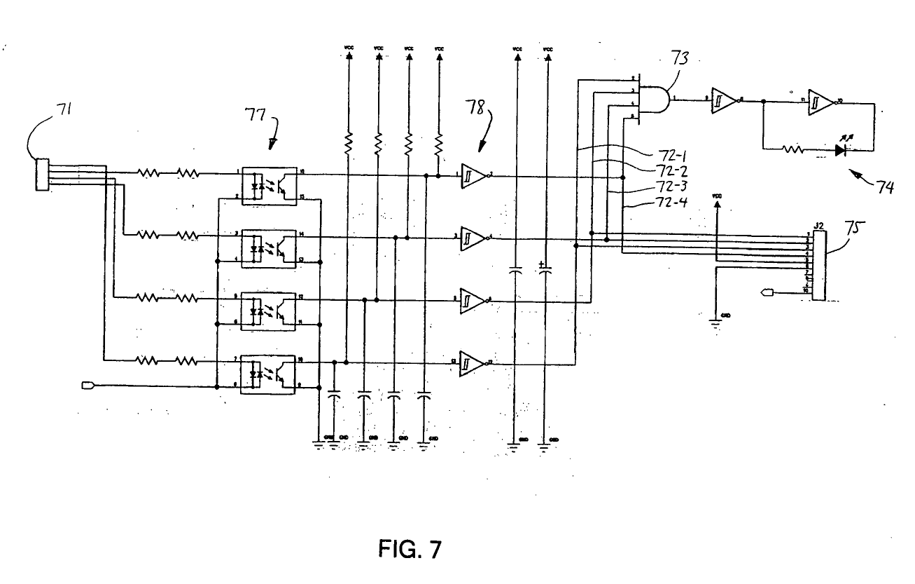

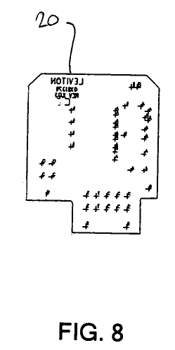

The diagnostic circuitry for each of the seven surge modules is shown schematically in FIG. 7. A connector 71 connects to the four TCO/MOV combinations in the module 1 (see FIG. 1), so that the status of each TCO is monitored.. In a surge event, the signal arriving through connector 71 will generally be high-voltage AC; optocouplers 77 are used to isolate the high-voltage AC from the low-voltage DC of the diagnostic circuit. The output signal from the optocouplers is buffered using NOT gates 78, thereby providing a clean digital logic signal as to whether an individual TCO is closed or open. The four signals 72-1, 72-2, 72-3, 72-4 (one for each TCO of the module 1 in this embodiment) are input to an AND gate 73. The output state of the AND gate will change when any of the four TCOs in the surge module becomes non-operational. The logical output of the AND gate 73 controls the red/green LED 74; the LED output is green when all of the TCOs are operational, and red when one or more are not operational. The four logic signals are also coupled to the connector 75 and thereby led to the main diagnostic board. The diagnostic circuitry shown schematically in FIG. 7 is physically realized on the PCB 20 shown in FIG. 8. As noted above, this PCB is part of the assembly 10 of the surge module.

The seven surge modules are mounted on a main PC board; in this embodiment, the main PC board is a six (6) layer PCB with copper plating (3 ounces/square foot) with high current carrying capability, details of which are given below. The main diagnostic board has the main diagnostic circuitry mounted thereon; this circuitry includes an open loop fast transient peak detector for measuring the phase and amplitude of a surge event, and also provides time and date stamping of the event.

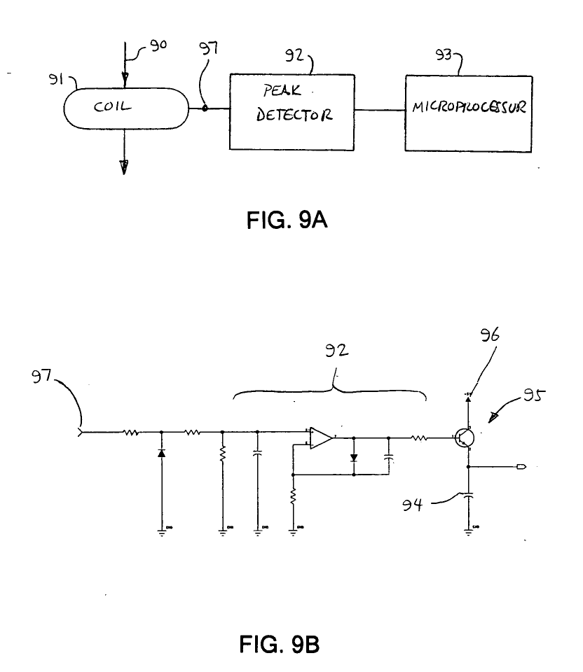

The surge sensing circuit in this embodiment of the invention is illustrated in the block diagram of FIG. 9A. The surge sensing circuit has a wire 90 passing through a coil 91 to generate a current signal which is representative of the surge voltage. This signal is connected to an input terminal 97 of a peak detector circuit 92, which in turn is coupled to a microprocessor 93. A very fast peak detector circuit is required to detect surges having a duration in the high nanosecond (ns to low microsecond (μs) (e.g.,. 800 ns to 10 μs) range. On the other hand, the peak detector must maintain the signal level representing the surge long enough for the microprocessor to read. As noted above, a conventional open loop peak detector coupled to a capacitor has a response speed limited by the charging rate of the capacitor. In this embodiment, the problem of response speed is addressed by coupling an emitter-follower to the capacitor. As shown in FIG. 9B, the emitter-follower 95 is a transistor where the input signal (the amplified transient from the op-amp of peak detector 92) is connected to the base of the transistor. The emitter is then connected to the capacitor 94. The transistor's collector is connected to a voltage source node 96. In this configuration, the transistor is used as a buffer to maintain the peak value of the capacitor voltage for the necessary period of time for the microprocessor to read.

The microprocessor (controlled by software typically written in C) is adapted to record the date, time and magnitude of a surge event, and store the surge information on a RAM chip. The microprocessor reads the digital value of the surge and converts it to a human-readable format to be displayed on the LCD (described below). The microprocessor also monitors the TCOs in the surge modules and causes warning messages to be displayed on the LCD when surge protection has been degraded.

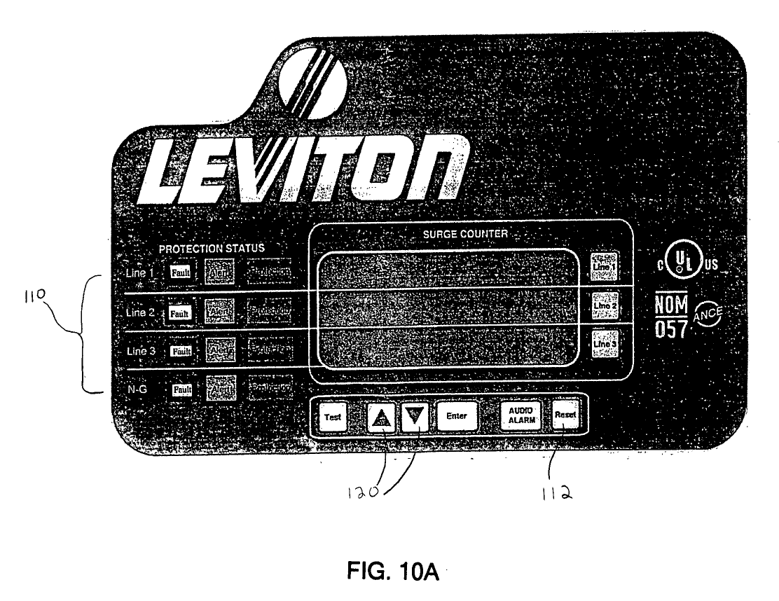

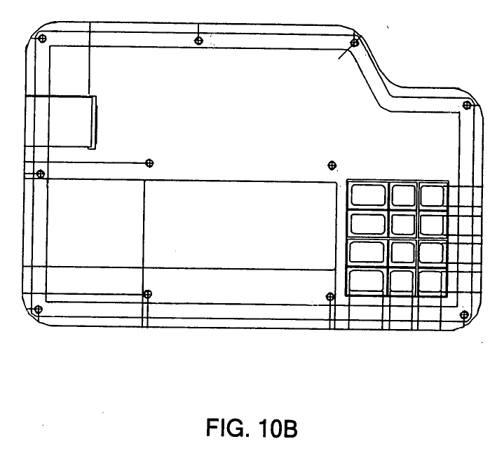

Diagnostic information is conveyed from the main diagnostic board to the user via a sub-panel which includes a liquid crystal display (LCD) and the membrane switch (FIGS. 10A and 10B). In this embodiment, the main diagnostic board contains twelve LEDs 110, visible on the sub-panel: 4 red, 4 yellow and 4 green for each line phase and neutral-to-ground. When all the TCOs for a given line are closed, the green LED is on. For example, if no faults are present between line 1 and neutral or between line 1 and ground, the green LED next to “Line 1” on the sub-panel will be lit (see FIG. 10A). When one TCO on a surge module opens, the green LED corresponding to that module will turn off and the yellow LED will turn on. When two or more TCOs on any of the surge modules open, the yellow and red LEDs corresponding to that module will turn on. When one or more TCOs open, an audible alarm will sound; the user will be able to disable the alarm by pushing a button (such as the “Reset” button 112 in FIG. 10A) or moving a switch to the “off” position.

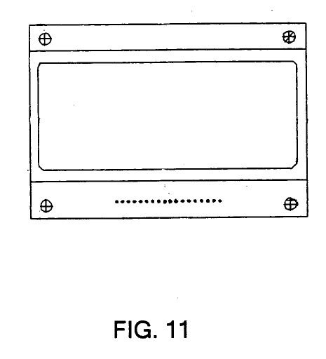

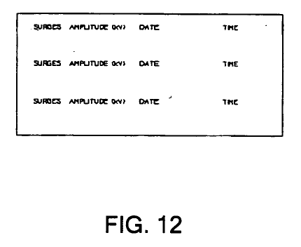

As shown in FIG. 10A, and more particularly in FIGS. 11 and 12, the LCD is used to display the surge information and the amount of protection a surge module is providing on a specific phase. During normal operation, the LCD will display the magnitude, date and time of a surge event. When a TCO opens, the LCD will toggle between the surge information and the amount of surge protection being provided. Additional information for the user's convenience (e.g. the manufacturer's telephone number) may also be displayed.

In this embodiment, the membrane switch buttons may be used to perform a number of functions: enable/disable the audio alarm; scroll through the stored surge data (using “up”and “down”buttons 120); download surge information; delete some or all of the stored surge information; perform diagnostics on the panel; and clear the LCD display. In addition, the user may download surge information to a computer using a standard RS-232 communication port.

The surge modules on the main PC board, the main diagnostic board, and the diagnostic display sub-panel may all be conveniently located inside a standard NEMA 4X enclosure, with the user interface (including a touch pad such as the above-described membrane switch) and the LCD on the exterior of a door thereof.

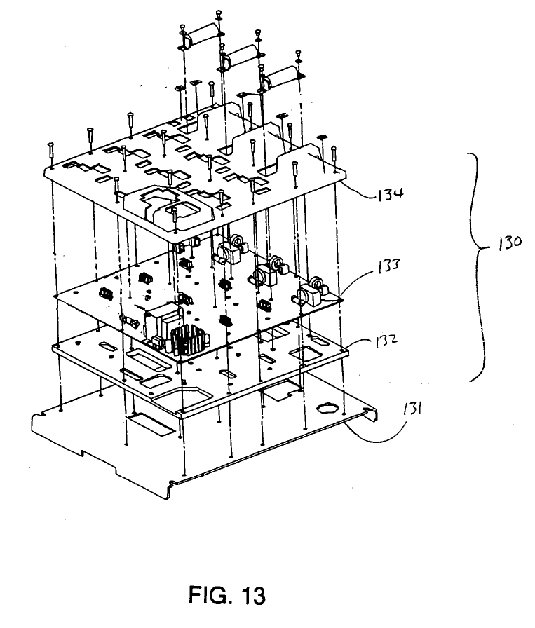

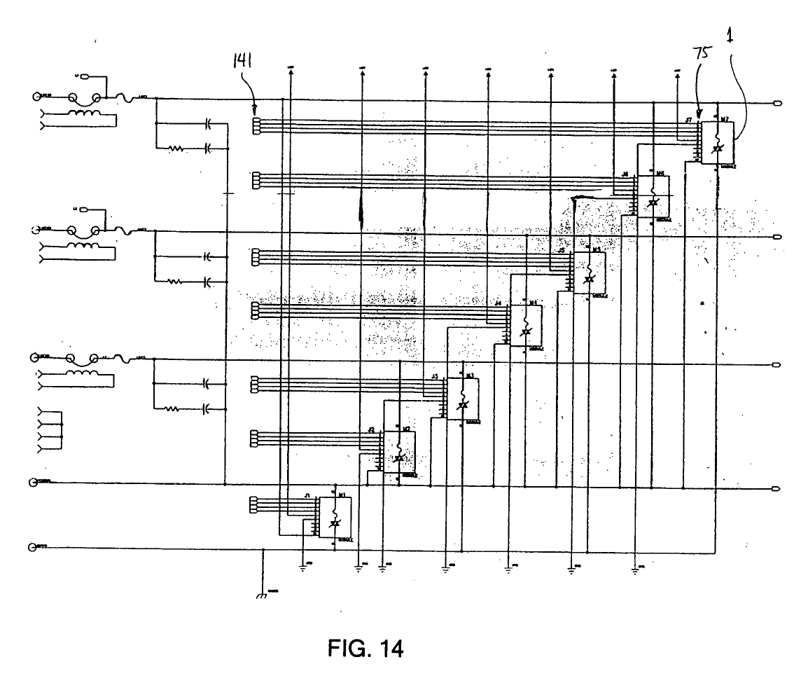

The main surge module assembly 130, illustrated in FIG. 13, includes a sheet metal mounting plate 131, a phenolic insulator 132, a PCB (the main surge module board) 133, and a thermal form cover 134. An electrical schematic diagram of the main surge module assembly is shown in FIG. 14. As noted above, each of the seven surge modules 1 has a connector 75, through which connections 141 are led to the main diagnostic board.

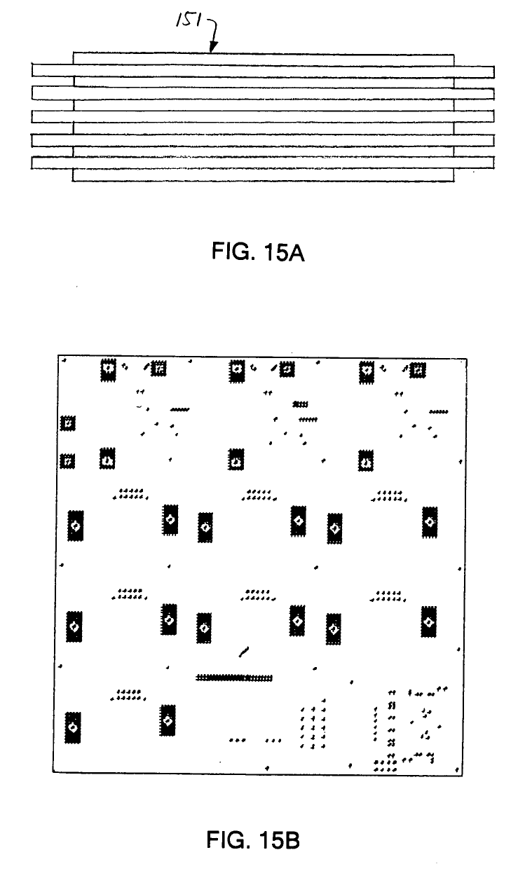

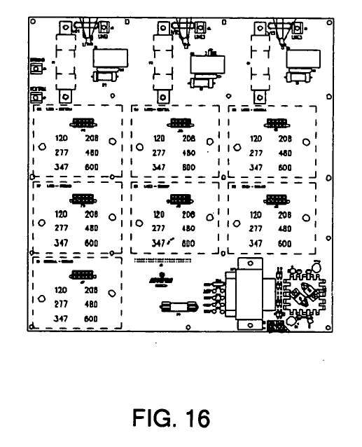

In a preferred embodiment, the PCB 133 has six layers of plated copper (3 ounces/square foot) interspersed with insulating material (see FIG. 15A). These six layers, beginning with the top (component) layer 151, are used respectively for component connections; diagnostics (low voltage); a neutral connection; a line voltage connection; chassis ground; and ground. FIG. 15B is a plan view of the PCB, showing how the seven surge modules, together with various other components, may be placed on the board. FIG. 16 is a plan view of the PCB populated with those components.

It is noteworthy that the main surge module PCB 133 has a large number of through holes having conductive material therein, which permit transfer of surge current to transfer from one layer of the PCB to another without degradation to the PCB. Using a PCB in high current surge applications is beneficial because of the relative short length of the traces and the close proximity of the traces which both assist in improving the clamping performance. This is an advantage over conventional arrangements using bus bars to transfer surge currents.

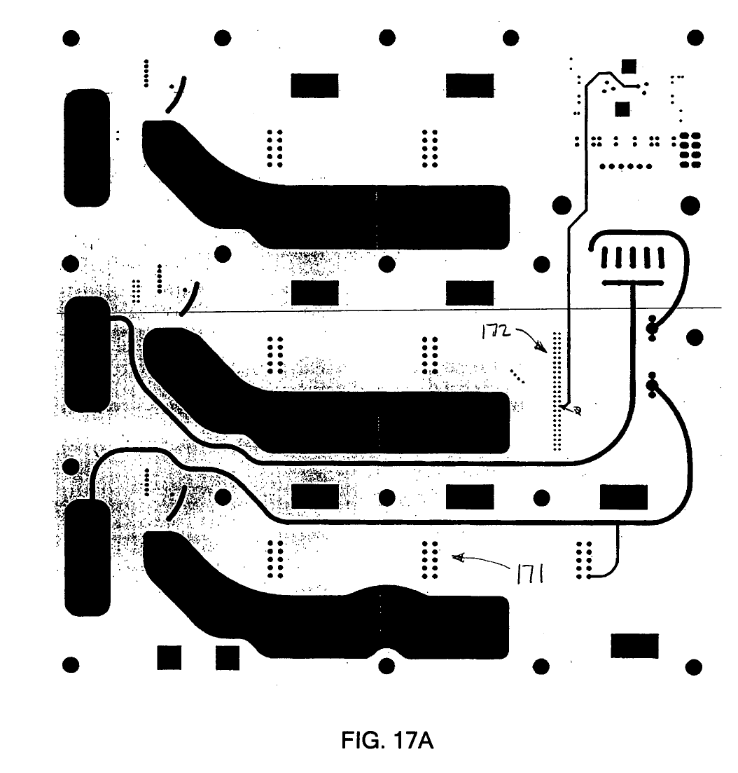

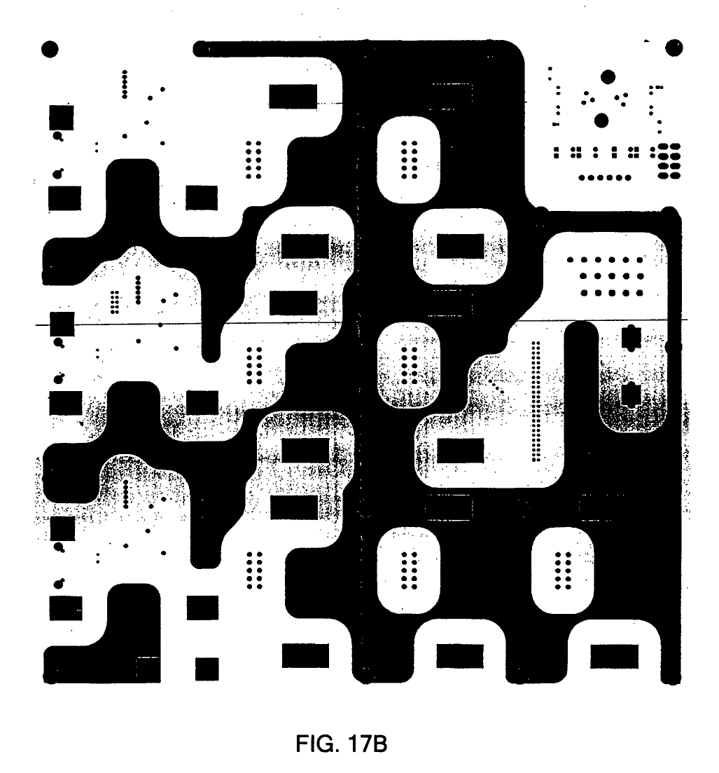

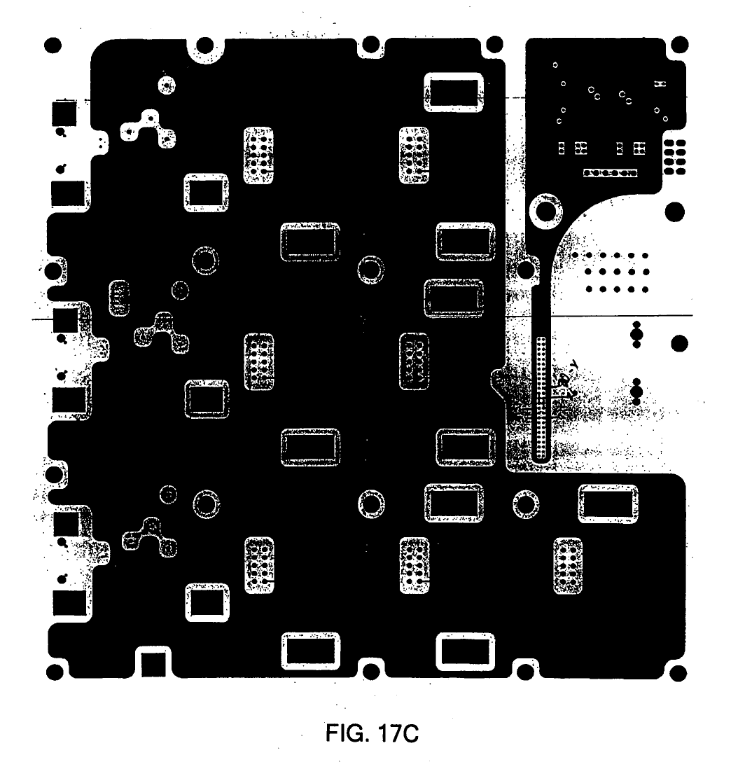

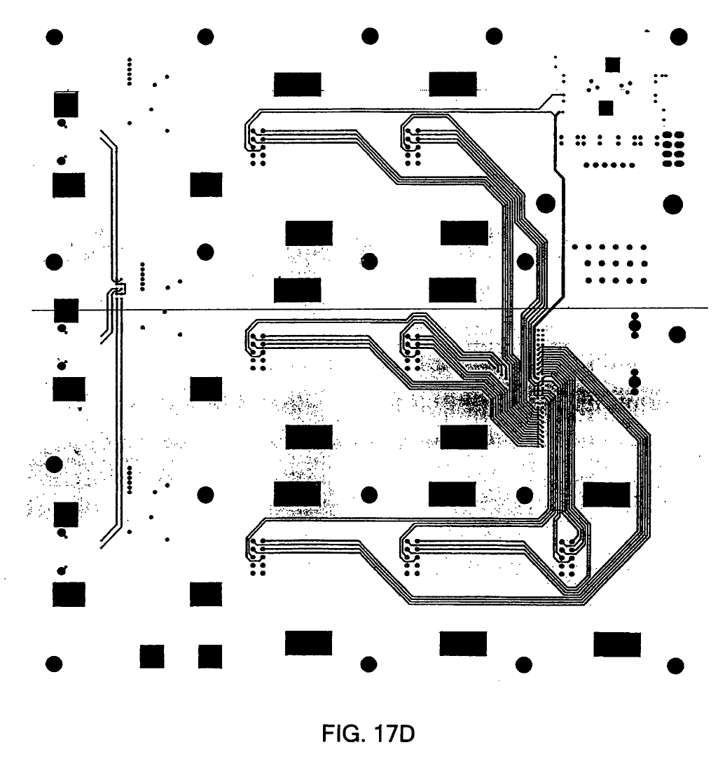

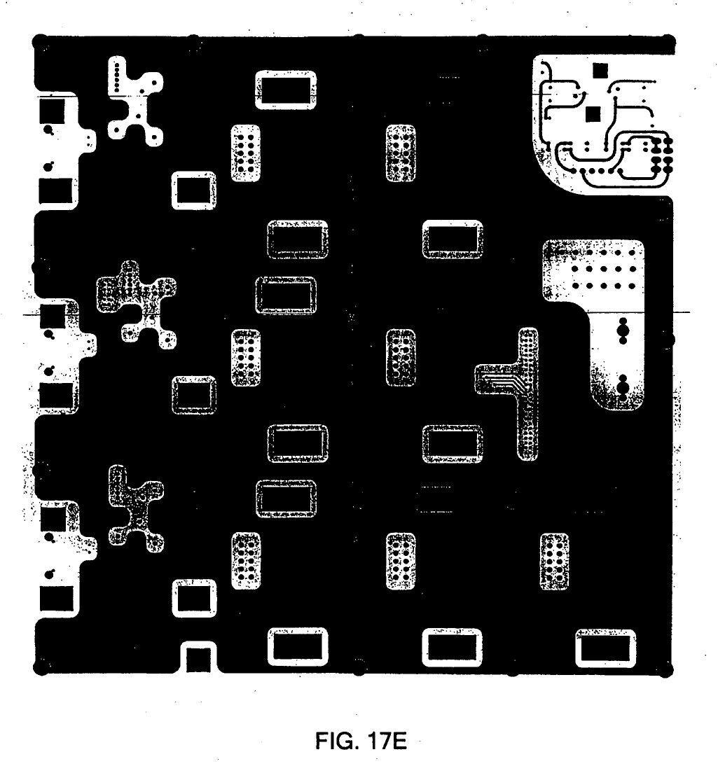

Different plated layers of PCB 133 are shown in FIGS. 17A-17E. Where connections are to be made from one layer to another, an array of holes is drilled completely through the PC Board. As shown in FIG. 17A, arrays 171 of 10 holes each are drilled in several locations; array 172 has 50 holes. In other locations, arrays may have up to 70 holes. The internal cylindrical surface of each one of these holes is plated with a conductive material (copper in this embodiment) and connections are made with the six conductive layers as needed. Therefore, although the plating operation leaves a relatively thin conductive layer, the use of arrays of many through-hole connections allows a large overall current capacity. Accordingly, a large surge current may be conducted from one layer of the PCB to another, thus avoiding damage to the PCB and other parts of the device.

Another benefit of this PCB arrangement derives from the parasitic capacitance of the short, closely spaced conductors in the through-hole arrays. The parasitic capacitance effectively provides an additional current path between the two closely spaced conductors. When a surge event occurs, some of the current will be shunted across the two conductors through this capacitance, thereby improving the clamping performance of the device.

While the invention has been described in terms of specific embodiments, it is evident in view of the foregoing description that numerous alternatives, modifications and variations will be apparent to those skilled in the art. Accordingly, the invention is intended to -encompass all such alternatives, modifications and variations which fall within the scope and spirit of the invention and the following claims.

We claim:

1. A surge protection device comprising:
a plurality of surge protection modules, each of said modules having a first terminal and a second terminal and connected to a first conductor at the first terminal and to a second conductor at the second terminal to provide surge protection between the first conductor and the second conductor;
a peak detector circuit coupled to each of said surge protection modules; and
a printed circuit board (PCB) having the surge protection modules mounted thereon, the PCB having
a plurality of conductive layers separated by insulating layers, and
a plurality of arrays of through holes extending through the PCB and having conducting material therein,
wherein the through holes are adapted to dissipate transient currents by passing the transient currents between the conductive layers through the conducting material.

2. A surge protection device according to claim 1, wherein the surge protection modules are mounted on a top conductive layer of the PCB, and the through holes cause the transient currents to pass from the top conductive layer to at least one other conductive layer of the PCB.

3. A surge protection device according to claim 1, wherein each array of through holes includes at least ten through holes.

4. A surge protection device according to claim 1, wherein the peak detector circuit includes an emitter-follower.

5. A surge protection device according to claim 4, wherein the peak detector circuit is an open-loop peak detector coupled to the emitter-follower, and the peak detector circuit is effective to detect surges having a duration in the range of about 800 ns to about 10 μs.

6. A surge protection device according to claim 1, further comprising a microprocessor coupled to the peak detector circuit for processing information regarding a surge event.

7. A surge protection device according to claim 6, wherein the information includes a surge amplitude and a time of the surge event.

8. A surge protection device according to claim 6, further comprising a memory device coupled to the microprocessor for storing the information.

9. A surge protection device according to claim 6, further comprising a display for displaying the information.

10. A surge protection device according to claim 8, further comprising a user interface for accessing the stored information.

11. A surge protection device according to claim 10, wherein the user interface includes a membrane switch.

12. A surge protection device according to claim 1, wherein the peak detector circuit includes an emitter-follower, and further comprising a diagnostic circuit coupled to each of the surge protection modules, each diagnostic circuit providing a signal in accordance with a level of surge protection for the corresponding surge protection module.

13. A surge protection device according to claim 12, further comprising a light-emitting diode (LED) displaying a color of light corresponding to the signal.

14. A surge protection device according to claim 1, wherein each surge protection module includes four parallel branches, each branch having a metal oxide varistor (MOV) and a thermal cut-off (TCO) device connected in series.

15. A surge protection device according to claim 14, further comprising a diagnostic circuit including a light-emitting diode (LED) coupled to each of the surge protection modules, wherein opening of a TCO in a given surge protection module causes a change in a color of light from the LED in the diagnostic circuit coupled to the surge protection module.

16. A surge protection device according to claim 1, wherein
one of the surge protection modules has the first terminal thereof connected to a neutral conductor and the second terminal thereof connected to a ground conductor, and each of the other surge protection modules has the first terminal thereof connected to a line phase conductor and the second terminal thereof connected to one of the neutral conductor and the ground conductor.

17. A surge protection panel comprising:
a main printed circuit board (PCB) having mounted thereon a plurality of surge protection modules;
a main diagnostic board having diagnostic circuits coupled to each of the surge protection modules; and
a diagnostic display sub-panel having
a display device for displaying diagnostic information stored by the diagnostic circuits, and
a user interface disposed on an exterior of the panel for retrieving the stored information,
wherein
the main PCB includes a plurality of a plurality of conductive layers separated by insulating layers, and a plurality of arrays of through holes extending through the PCB and having conducting material therein, the through holes being adapted to dissipate transient currents by passing the transient currents between the conductive layers through the conducting material,
the diagnostic circuits each include an open-loop peak detector with an emitter-follower coupled thereto, and
the information includes a surge amplitude and a time of a surge event.

18. A surge protection method comprising the steps of:
conducting a transient current in a surge event through a surge protection module, the surge protection module being mounted on a multilayer printed circuit board (PCB);
shunting the transient current between layers of the PCB via a plurality of arrays of through holes extending through the PCB and having conducting material therein, thereby dissipating the transient current;
detecting a peak of the transient current;
displaying diagnostic information regarding the surge protection modules;
storing information regarding the surge event; and
displaying information regarding the surge event.

19. A surge protection method according to claim 18, wherein said detecting is performed using an open-loop peak detector circuit coupled to an emitter-follower.

20. A surge protection method according to claim 18, wherein said detecting further comprises detecting a magnitude of the transient current, and the information regarding the surge event includes said magnitude and a time of the surge event.
